(19) United States
(12) Patent Application Publication
(10) Pub. No.: US 2006/0272584 A1
(43) Pub. Date: Dec. 7, 2006

(54) Restricted access pet feeding device

(76) Inventor: Frederick Sprague, Baileyville, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(21) Appl. No.: 11/446,658

(22) Filed: Jun. 5, 2006

Related U.S. Application Data
(60) Provisional application No. 60/687,702, filed on Jun. 6, 2005.

(51) Int. Cl. A01K 61/02

(52) U.S. Cl. 119/52.4

(57) ABSTRACT

An improved pet feeding device comprising a substantially box-like structure with restricted access to food and/or water placed therein, access being controlled by one or more apertures in the deice suitable for allowing smaller sized pets to pass through while denying larger sized pets access, thereby improving control over the feeding of individual pets in a multi-pet household.

### CROSS REFERENCE TO RELATED APPLICATION

This application claims priority to a provisional application, U.S. Ser. No. 60/687,702, filed Jun. 7, 2005, entitled Restricted Access Pet Feeding Device, by Sprague, Frederick, which is hereby incorporated by reference.

### BACKGROUND OF THE INVENTION

1. Technical Field

The invention relates generally to the field of pet feeding stations. More specifically, the invention is directed to an improved pet feeding device suitable for allowing smaller sized pets access to food while denying larger sized pets access, thereby improving control over the feeding of individual pets in a multi-pet household.

2. Description of Prior Art

Pet feeding stations with restricted access are known in the art. They generally involve a type of superstructure to hold or enclose a pet food container and have a means of controlling access, usually through one or more apertures in the superstructure. Examples are disclosed in U.S. Pat. No. 4,029,051, “Animal Feeding And Protective Device” (McKinney); U.S. Pat. No. 5,133,291, “Pet Feeding Station” (Justice); U.S. Pat. No. 6,360,689, “Cat Feeder” (Weinert); and U.S. Pat. No. 6,588,367, “No Dog Cat Feeder” (MacManus). However, known designs are all inferior to some extent. Some devices (e.g., McKinney, MacManus) allow only a portion of the pet to enter the superstructure, thereby causing some pets, such as cats, to avoid using the device because it leaves their bodies exposed while obscuring their vision while feeding. Other devices are not practical from the pet owners perspective (e.g., Justice), being either difficult to clean or unable to contain messes such as spilled food or water created by the feeding pet. Still others require complicated installation or inconvenient siting (e.g., Weinert). None of the prior art devices provides the pet with a secure yet inviting feeding station while minimizing mess to allow for placement anywhere within the home.

It is an objective of the present invention to provide a useful, aesthetically pleasing pet feeding device which permits access to smaller pets while restricting access to larger pets.

It is a further objective of the present invention to provide a pet feeding device that effectively contains both the pet's food, water, and food containers and the mess created by the pet while feeding, such that a minimal amount of food and/or water is permitted to spill from the interior of the pet feeding device.

It is a further objective of the present invention to provide a pet feeding device that is attractive to pets to encourage the pet to use the device.

It is a further objective of the present invention to provide a pet feeding device which is easy for the pet owner to use and clean.

It is a further objective of the present invention to provide a pet feeding device which may be placed anywhere in the pet owner's home.

Other objectives of the present invention will be readily apparent from the description that follows.

### SUMMARY OF THE INVENTION

Households with multiple pets often wish to control the feeding behavior of the individual pets. This is especially true with regard to households having both cats and dogs. These animals typically have different dietary needs as well as different feeding habits. Cats typically feed by consuming food in small amounts over the course of an entire day, while dogs typically consume as much food as possible at one time. Thus, households having both cats and dogs often experience the situation where the dogs consume the cats' food as well as their own food, leading to overfeeding of the dogs and underfeeding of the cats. This may also occur where the household has only dogs, but some of the dogs are large and some are small. A typical solution is to segregate the individual pets' food, but that is not often practical. When cats and dogs are involved, segregation may involve taking advantage of a cat's ability to climb or jump onto elevated surface, where a dog may not have access. Such surfaces may not be available, however, or undesirable for a pet to access (such as a table top), or the smaller pet may be unable to access the surface (do to age or other impairment). Also, messes created by the feeding pet are more visible when elevated. Another solution is to physically separate the pets for feeding. However, this becomes inconvenient for the user, especially with pets which feed over the course of an entire day. A device which restricts access to certain food is therefore desirable to prevent overeating by certain pets while allowing other pets access to that food consistent with their own feeding habits.

The present invention solves the problem of uncontrolled access to pet food by providing an aesthetically pleasing and functional device to contain the pet food and restrict access thereto. The present invention in its preferred embodiment is substantially a decorative box with a hinged top and a floor, with at least one screened side and one solid side, with at least one aperature in one said solid side, not including the floor. The aperture may be adjusted to control for different sized animals, or to take into account growth in a pet. The aperture is sized to allow access to the interior by a smaller pet but to prevent access by a larger pet. Food and/or water is placed into the present invention through the top, and then the top is closed. The screened side(s) allow the pet to perceive the food, either visually or by smell, thereby encouraging use of the device. They also permit the pet to observe its surroundings while feeding, adding a sense of security for wary pets. Cleaning of the device is facilitated by the hinged top and the screened side(s), and the portability of the device (which may be moved to a location for cleaning different from the location normally used for feeding).

Other features and advantages of the invention are described below

### DESCRIPTION OF THE DRAWINGS

FIG. 1 is a perspective view of the pet feeding device depicting the basic components of same, with the top panel in a partially opened position. The access control device is depicted in ghost lines as it is positioned behind the first lateral panel.

FIG. 2A is a partial plan view of one embodiment of the top panel having a circumferential rim.

FIG. 2B is a partial plan view of another embodiment of the top panel having a recessed rim.

FIG. 3 is a partial plan view of an embodiment of the bottom panel attached to the lateral panels at a point above their respective lower edges. The third lateral panel is not shown.

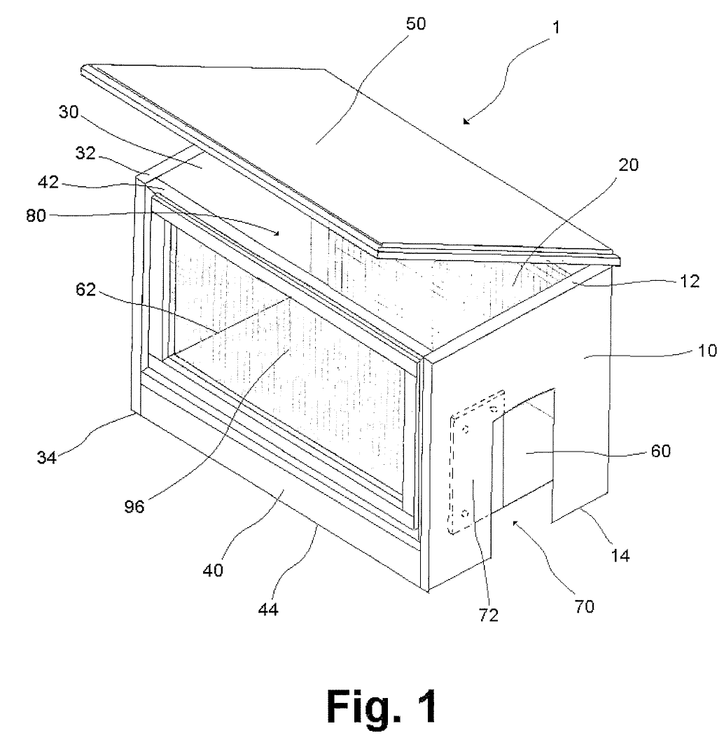

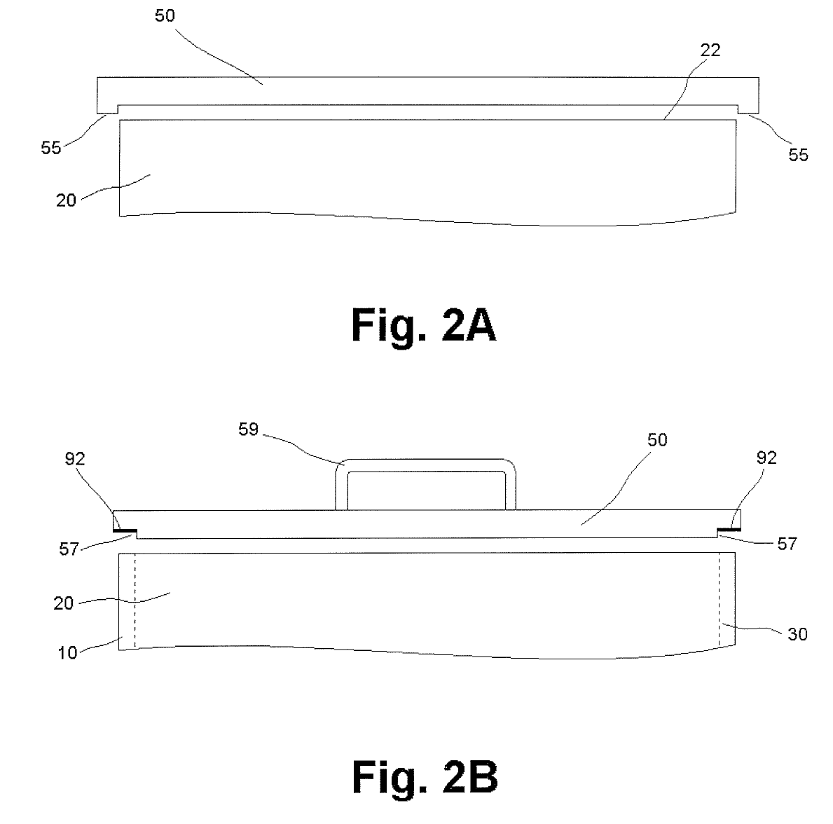

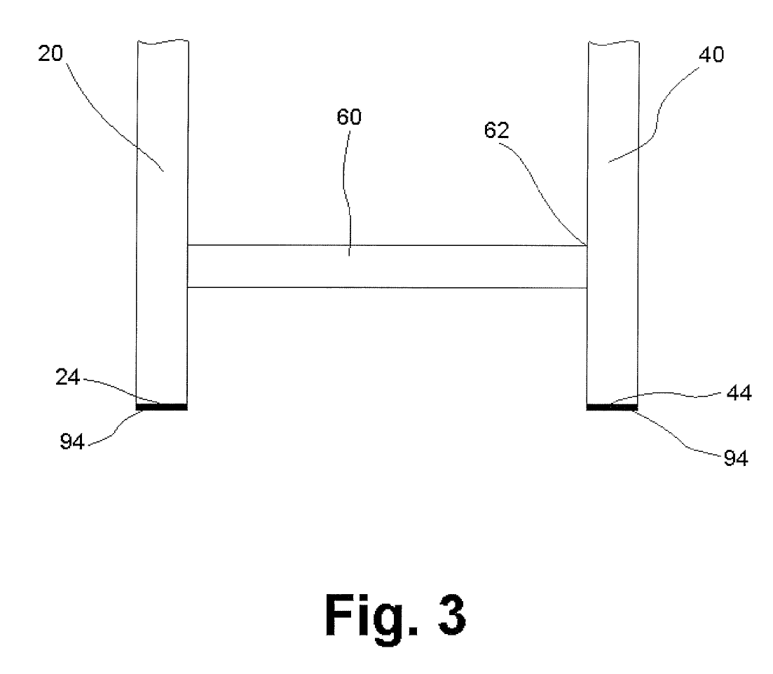

### DESCRIPTION OF THE INVENTION

The restricted access pet feeding device 1 of the present invention comprises six sides defining a substantially enclosed space, said sides interacting with each other to form a substantially rectangular box. The space enclosed by the sides is defined as the interior 80 of the pet feeding device 1.

Four of the six sides are lateral, each having a substantially vertical orientation. The lateral sides are designated first lateral panel 10, second lateral panel 20, third lateral panel 30, and fourth lateral panel 40. The first lateral panel 10 and the third lateral panel 30 are oriented substantially parallel to and opposite each other, and the second lateral panel 20 and the fourth lateral panel 40 are oriented substantially parallel to and opposite each other. The first lateral panel 10 is adjacent to and substantially perpendicular to the second lateral panel 20 and the fourth lateral panel 40. The third lateral panel 30 is adjacent to and substantially perpendicular to the second lateral panel 20 and the fourth lateral panel 40. Each lateral panel 10,20,30,40 has an upper edge 12,22,32,42 and a lower edge 14,24,34,44.

The two sides of the pet feeding device 1 which are not lateral panels form a top to the pet feeding device 1, designated the top panel 50, and a bottom to the pet feeding device 1, designated the bottom panel 60. The top panel 50 is placed onto the upper edges 12,22,32,42 of the lateral panels 10,20,30,40. Preferably, the top panel 50 is hingedly attached to the upper edge of one of the lateral panels. In the preferred embodiment the top panel 50 is attached to the upper edge of one of the lateral panels by a full length piano hinge. Said piano hinge may be made of brass or another decorative metal. A spring lid support, attached to the top panel 50 and a lateral panel, may also be used to facilitate positioning the top panel 50. In an alternate embodiment, the top panel 50 may comprise a circumferential lip 55 which fits over the upper edges 12,22,32,42 of the lateral panels 10,20,30,40 to secure the top panel 50 to the pet feeding device 1. In yet another alternate embodiment the top panel 50 may comprise a recessed rim 57 which fits against and interior to the lateral panels 10,20,30,40 to secure the top panel 50 to the pet feeding device 1. A handle 59 may be affixed to the top panel 50 to facilitate its positioning. Padding 92 may be attached to the top panel 50 and/or one or more of the upper edges of the lateral panels to provide a noise dampener at points of contact between the top panel 50 and the lateral panels 10,20,30,40.

The top panel 50 is deemed to be in a closed position when it substantially covers an upper portion of the pet feeding device 1, thereby preventing access to the interior 80 therefrom. The top panel 50 is deemed to be in an opened position when it is positioned to uncover at least a portion of the upper portion of the pet feeding device 1. When in the closed position the top panel 50 is oriented substantially horizontally and substantially perpendicular to the lateral panels 10,20,30,40. When in the opened position the top panel 50 permits access into the interior 80 of the pet feeding device 1.

The bottom panel 60 is non-porous and oriented substantially horizontally and substantially perpendicular to each of the four lateral panels 10,20,30,40, being joined with the lateral panels 10,20,30,40 in a manner well-known in the art such that seams 62 between each lateral panel 10,20,30,40 and the bottom panel 60 are substantially sealed. The bottom panel 60 may be joined with the lateral panels 10,20,30,40 flush with the lower edges 14,24,34,44 of the lateral panels 10,20,30,40, such that the bottom panel 60 is placed against a surface, such as the floor of a room. Alternately, the bottom panel 60 may be joined with the lateral panels 10,20,30, 40 at locations above the lower edges 14,24,34,44 of the lateral panels 10,20,30,40, thereby forming a space under the bottom panel 60. Padding 94 may be attached to the bottom panel 60 and/or one or more of the lower edges of the lateral panels to provide protection at points of contact between the device 1 and a surface on which the device 1 is placed, such as a floor.

At least one of the five non-bottom panels (e.g., the first, second, third, and fourth lateral panels 10,20,30,40 and the top panel 50) contains a first aperture 70, said first aperture 70 suitably configured to allow a small animal to enter into the interior 80 of the pet feeding device 1, while preventing a larger animal from entering. Alternately a second aperture, similarly configured, may be located on another of the five non-bottom lateral panels. For example, the device 1 may comprise the first aperture 70 on the first lateral panel 10; the device 1 may comprise the first aperture 70 on the first lateral panel 10 and the second aperture on the third lateral panel 30; the device 1 may comprise the first aperture 70 on the second lateral panel 20 and the second aperture on the top panel 50; or the device 1 may comprise the first aperture 70 on the top panel 50 only. Other combinations and configurations are also contemplated.

In the preferred embodiment the first aperture 70 has associated with it an aperture control component, suitably adapted to alter the size of the first aperture 70 through which a pet may pass. The aperture control component may be a flat panel 72 which is affixed to a lateral side in a manner suitable to partially or completely cover the first aperture 70. It may also be a bar which restricts the opening, or an adjustable diaphragm, or any other suitable device. As more of the first aperture 70 is covered by the aperture control component, access there through to the interior 80 of the pet feeding device 1 is restricted to ever smaller pets. When the first aperture 70 is fully covered by the aperture control component no access into the interior 80 of the device 1 may occur through the first aperture 70. If the device 1 comprises a second aperture, there may be associated with the second aperture an aperture control component configured similarly to the aperture control component of the first aperture 70.

In the most preferred embodiment the aperture control component is a flat panel 72 dimensioned larger than the first aperture 70 with which it is associated, said flat panel 72 having multiple orifices, each orifice suitable to receive a fastener. The panel containing the first aperture 70 also has multiple orifices which may be aligned with the orifices of the flat panel 72, with the flat panel 72 affixed to said panel by passing fasteners though the aligned orifices of the flat panel 72 and said panel. The locations of the orifices of said panel determine the placement of the flat panel 72 over the first aperture 70. If the device 1 comprises a second aperture, there may be associated with the second aperture a flat panel configured similarly to the flat panel 72 of the first aperture 70, with the panel containing the second aperture configured similarly to the panel containing the first aperture 70.

At least one of the lateral panels is comprised at least in part of a screen 96, permitting visibility into the interior 80 of the pet feeding device 1 and allowing natural light to enter and odors to exit the pet feeding device 1. In the preferred embodiment the screen 96 is constructed of small mesh metal. Said screen 96 may be framed within the remaining portion of the lateral panel or may alternately comprise the entire lateral panel. Preferably two opposite lateral panels comprise screens 96. A lateral panel containing the first aperture 70 should not comprise a screen 96.

The top panel 50, the bottom panel 60, and the portions of the lateral panels 10,20,30,40 not constructed of screening material 96 should be constructed of a rigid, durable material. In the preferred embodiment this material is wood, preferably pine. It may also be plastic, metal, a composite material, or a combination of two or more of the foregoing. The panels 10,20,30,40,50,60 of the pet feeding device 1 may be painted, stained, sculpted, or otherwise made decorative.

The pet feeding device 1 functions by a user opening the top panel 50 and placing food and/or water, preferably contained in feeding devices such as bowls, within the interior 80 of the pet feeding device 1, then closing the top panel 50. The pet may see and smell the food and/or water from the exterior of the pet feeding device 1, thereby enticing the pet to enter the interior 80 of the pet feeding device 1 through one of the apertures. Upon entering the pet feeding device 1, the pet has access to the food and/or water. The pet may place itself entirely within the interior 80 of the pet feeding device 1, thereby avoiding leaving any portion of its body exposed while feeding. Larger pets cannot enter through the aperture(s), thereby preventing them from disturbing the feeding pet and preventing them from accessing the food and/or water placed within the pet feeding device 1. Any messes created by the feeding pet will be substantially contained within the pet feeding device 1. Messes may be easily cleaned by the user opening the top panel 50. The pet feeding device 1 may also be easily removed from its normal location to a cleaning location, and cleaning may be accomplished remotely, for example with a hose. By containing the messes created by the feeding pet, the pet feeding device 1 is suitable for placement anywhere within the home, and may be easily relocated even when containing food and/or water.

Modifications and variations can be made to the disclosed embodiments of the invention without departing from the subject or spirit of the invention.

I claim:

1. A pet feeding device invention comprising
a first lateral panel, being substantially planar and having an upper edge and a lower edge, said first panel having a substantially vertical orientation;
a second lateral panel, being substantially planar and having an upper edge and a lower edge, said second panel having a substantially vertical orientation and being adjacent to and substantially perpendicular to the first lateral panel;
a third lateral panel, being substantially planar and having an upper edge and a lower edge, said third panel having a substantially vertical orientation and being adjacent to and substantially perpendicular to the second lateral panel and oriented substantially parallel to and opposite the first lateral panel;
a fourth lateral panel, being substantially planar and having an upper edge and a lower edge, said fourth panel having a substantially vertical orientation and being adjacent to and substantially perpendicular to the first lateral panel and the third lateral panel and oriented substantially parallel to and opposite the second lateral panel;
a top panel, being substantially planar and having a substantially horizontal orientation, said top panel suitably adapted to being placed onto the upper edges of the four lateral panels;
a bottom panel, being substantially planar and having a substantially horizontal orientation and constructed of a substantially non-porous material, said bottom panel attached to the lower edges of the four lateral panels in any manner well-known in the art such that seams between each lateral panel and the bottom panel are substantially sealed; and
a first aperture, said first aperture formed into one of the group of the first lateral panel, the second lateral panel, the third lateral panel, the fourth lateral panel, and the top panel;
whereby the six panels define a substantially enclosed space, said panels interacting with each other to form a substantially rectangular box, said substantially enclosed space defined as the interior of the pet feeding device,
the first aperture is suitably configured to allow access into the interior of the pet feeding device,
the top panel further has a closed position wherein the top panel substantially covers an upper portion of the pet feeding device, thereby preventing access to the interior of the pet feeding device therefrom, whereby the top panel in the closed position is oriented substantially horizontally and substantially perpendicular to the four lateral panels, and
the top panel further has an opened position wherein the top panel is positioned to uncover at least a portion of the upper portion of the pet feeding device, permitting access into the interior of the pet feeding device.

2. The pet feeding device of claim 1 wherein the top panel is hingedly attached to the upper edge of one of the lateral panels.

3. The pet feeding device of claim 2 wherein the top panel is hingedly attached to the upper edge of one of the lateral panels by a full length piano hinge.

4. The pet feeding device of claim 2 wherein the top panel further comprises a spring lid support, said spring lid support being attached to the top panel and the lateral panel to which the top panel is hingedly attached.

5. The pet feeding device of claim 1 wherein the top panel comprises a circumferential lip which fits over the upper edges of the lateral panels to secure the top panel to the pet feeding device when the top panel is in the closed position.

6. The pet feeding device of claim 1 wherein the top panel comprises a recessed rim which fits against and interior to the lateral panels to secure the top panel to the pet feeding device when the top panel is in the closed position.

7. The pet feeding device of claim 1 wherein the top panel comprises a handle, said handle being affixed to the top panel and being suitably adapted to facilitate the positioning of the top panel.

8. The pet feeding device of claim 1 further comprises padding, said padding being attached to at least one of the top panel and the upper edges of the four lateral panels such that when the top panel is in the closed position said padding is disposed between the top panel and at least some portion of one or more of the upper edges of the lateral panels.

9. The pet feeding device of claim 1 wherein the bottom panel is joined with the lateral panels flush with the lower edges of the lateral panels.

10. The pet feeding device of claim 1 wherein the bottom panel is joined with at least two opposing lateral panels at a location between the lower edges of said at least two opposing lateral panels and the respective upper edges of those lateral panels, thereby forming a space under the bottom panel.

11. The pet feeding device of claim 1 wherein the bottom panel comprises base padding suitably located so as to be disposed between the bottom panel and at least one point of contact of the bottom panel with a surface on which the pet feeding device is placed.

12. The pet feeding device of claim 1 wherein the lower edges of at least two opposing lateral panels comprise base padding suitably located so as to be disposed between said lower edges of said opposing lateral panels at points of contact of said opposing lateral panels with a surface on which the pet feeding device is placed.

13. The pet feeding device of claim 1 further comprising an aperture control component, suitably adapted to dynamically alter the size of the first aperture thereby restricting the size of a pet which may pass through the first aperture.

14. The pet feeding device of claim 14 wherein the aperture control component comprises a flat panel which is removably affixed to the panel into which the first aperture is formed in a manner suitable to partially cover the first aperture.

15. The pet feeding device of claim 1 further comprising a second aperture, said second aperture is suitably configured to allow access into the interior of the pet feeding device, said second aperture formed into one of the group of the first lateral panel, the second lateral panel, the third lateral panel, the fourth lateral panel, and the top panel, excluding the panel into which the first aperture is formed.

16. The pet feeding device of claim 15 further comprising a second aperture control component, suitably adapted to dynamically alter the size of the second aperture thereby restricting the size of a pet which may pass through the second aperture.

17. The pet feeding device of claim 16 wherein the second aperture control components comprises a flat panel which is removably affixed to panel into which the second aperture is formed in a manner suitable to partially cover the second aperture.

18. The pet feeding device of claim 1 wherein at least one of the lateral panels is comprised at least in part of a screening material.

19. The pet feeding device of claim 18 wherein the screening material is a small mesh metal.

20. The pet feeding device of claim 18 wherein two opposite lateral panels are comprised at least in part of a screening material.
